(19) United States
(12) Patent Application Publication
(10) Pub. No.: US 2010/0176523 A1
(43) Pub. Date: Jul. 15, 2010

(54) Device for and Method of Manufacturing Optical Part

(76) Inventors: Kanji Sekihara, Aichi (JP); Naoki Kaneko, Aichi (JP); Akihiko Matsumoto, Aichi (JP); Shinichiro Hara, Aichi (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/438,268

(22) PCT Filed: Aug. 17, 2007
(86) PCT No.: PCT/JP2007/066024

§ 371 Date: Feb. 20, 2009

(30) Foreign Application Priority Data
Aug. 30, 2006 (JP) 2006 234372

(51) Int. Cl. B29C 45/78; B29D 11/00

(52) U.S. Cl. 264/2.7; 425/144

(57) ABSTRACT

A device to manufacture an optical component, wherein a fixed metal mold 5 and a movable metal mold 6 are clamped to each other while controlling a temperature, and a molding material is injected into the cavity therebetween. In the device, there are disposed electrothermal conversion elements 15 and 25 to control the temperature by electrothermal conversion in response to an electric input, and a medium temperature control section 8 to control the temperature through heat exchange by circulating a heating medium in medium flow paths 16 and 26 in the device from an outside of the device.

### TECHNICAL FIELD PERTAINING TO THE INVENTION

The present invention relates to an optical component manufacturing device to form an optical component through injection molding by injecting a resin into a metal mold, and in particular to an optical component manufacturing device and the manufacturing method thereof to form the optical component while controlling temperature.

### PRIOR ART

There have been manufactured various kinds of molded components by injection molding using metal molds. Generally, in the injection mold devices, a melted resin is injected into a cavity configured with a fixed metal mold and a movable metal mold and cooled to be solidified in the molds. Here, if a temperature fluctuation of the mold or a temperature distribution in the mold occurs, there is a possibility that a variations in performance of the molding products occur. In the past oil temperature control using an external temperature controller has been popularly utilized, however, it tends to be affected by atmospheric temperature and variations of molding temperature have been occurred in a range of ±1° C. in successive molding. On the other hand, to achieve a desired quality in molding an optical component such as an optical lens, the variations of mold temperature have been required to be suppressed below ±0.3° C.

To cope with the forgoing, for example, in the unexamined Japanese patent application publication No. H11-42682, various countermeasures are disclosed to reduce temperature variations in molding a lengthy optical element. For example, in the above patent document, there is disclosed a metal mold having a plurality of heaters at a vicinity of the cavity of the metal mold and controllers to control the heaters thereof. Thereby it is said that a discretionary temperature distribution is realized and optical distortion is avoided.

Patent Document: unexamined Japanese patent application publication No. H11-42682

### DISCLOSURE OF THE INVENTION

### Problems to be Solved by the Invention

However, in such case as the conventional technology in the forgoing where a closed control by the heaters and the control sections of thereof are utilized, the control has to be performed in consideration of a thermal capacity. In particular, an optical component metal mold to produce a large number of optical components is generally large in size. Thus since temperature distribution of the metal mold is broad and atmospheric temperature affects materially, there is a problem that the control becomes complicated. Further, to raise the temperature of entire metal mold up to a molding temperature, a plurality of heaters having a large capacity are required, which is not preferable from the view point of energy saving.

The present invention is to solve the problems of conventional technologies in the forgoing. An object of the present invention is to provide an optical component manufacturing device and the manufacturing method thereof where a stable mold temperature is obtained with easy control by suppressing an effect of atmospheric temperature.

### Means to Solve the Problems

The optical component manufacturing device of the present invention to attain the above problems is an optical component manufacturing device to manufacture an optical component by injecting a molding material into a cavity between a fixed metal mold and a movable metal mold which are clamped and subject to temperature control, having: an electrothermal conversion element disposed in the device thereof to perform temperature control by electrothermal conversion in response to an electrical input; and a medium temperature control section to perform temperature control by heat exchange by circulating a heating medium.

According to the optical component manufacturing device of the present invention, the fixed metal mold and the movable metal mold are clamped while controlling temperature. The optical component manufacturing device has a medium temperature control section and electrothermal conversion element. Here, responsiveness of the medium temperature control section is relatively low, since the medium temperature control section carries out temperature control by heat exchange by circulating a heating medium from the outside. On the other hand, since the electrothermal conversion element carries out temperature control by electrothermal conversion in response to an electric input, the responsiveness is high. Therefore, the temperature of the entire metal mold is controlled by the medium temperature control section and the temperature of a vicinity of the cavity, for instance, is controlled by the electrothermal conversion element. Therefore, in the optical component manufacturing device of the present invention, an effect of atmospheric temperature can be suppressed and a stable mold temperature can be obtained with simple control.

Further, in the present invention, it is preferred that the electrothermal conversion element is disposed between the medium flow path of the medium temperature control section and the cavity, observing from a direction perpendicular to the direction of mold clamping. In this way, the temperature of the icinity of the cavity can be precisely controlled by the electrothermal conversion element.

In addition, in the present invention, it is preferred that a base member to retain the fixed metal mold or the movable metal mold is provided, the electrothermal conversion element is provided at the fixed metal mold or the movable metal mold, and the medium flow path of the medium temperature control section is provided at the based member. In this way, arrangement is easy and the stable mold temperature can be obtained.

Furthermore, according to the present invention, it is preferred that the fixed metal mold or the movable metal mold has a plurality of cavities having molding plates and molding surfaces,

the electrothermal conversion element includes a cavity electrothermal conversion element to control the temperature of the cavity and a molding plate electrothermal conversion element to control the temperature of the molding plate, and a control section is provided to control temperature by controlling the cavity electrothermal conversion and the molding plate electrothermal conversion element by closed control while monitoring the cavity temperature and the molding plate temperature. In the above configuration, the temperature control of the cavity can be carried out more precisely. Here, the cavity electrothermal element is disposed at a position immediately near the cavity, and the molding plate electrothermal conversion element is disposed at a position far from the cavity compared to the cavity electrothermal conversion element. Meanwhile, the closed control refers to a control method to repeat a loop where a temperature of a vicinity of a portion to be controlled is measure directly, the measurement result is compared with a target value and an output to the electrothermal conversion element is controlled.

Further, in the present invention, the cavity electrothermal conversion element is preferred to be disposed in the cavity. Thus the temperature control of the cavity can be carried out more reliably.

Further, according to the present invention, in the fixed metal mold or the movable metal mold, it is preferred that a heater plate, in which the cavity electrothermal conversion element is built-in, is disposed between the cavity and the base plate, whereby the replacing work of the electrothermal conversion element is not bothersome even if the metal mold has a configuration where the cavity is separated from the base member.

Further, according to the present invention, it is preferred that the all the cavities are disposed within an area confined by the molding plate electrothermal conversion element and a line segment connecting both ends of the molding plate electrothermal conversion element thereof, whereby the effect of atmospheric temperature can be surely suppressed and a temperature difference between the cavities in successive molding can fall within 2° C. In case the electrothermal conversion element is in the shape of a circle, an area confined by the element thereof is the area thereof.

Further, according to the present invention, it is preferred that the fixed metal mold or the movable metal mold has a plurality of the cavities having molding surfaces, the electrothermal conversion element controls temperature of the cavities, and the medium temperature control section controls temperature of portions of the fixed metal mold or the movable metal mold except the cavities. Whereby the temperature of the portions except the cavities can be controlled by the medium temperature control section relatively slow. On the other hand, the cavities are precisely controlled by the electrothermal conversion element. Therefore, for example, in the metal mold whose temperature is controlled by the medium temperature control section within a target temperature of ±1° C., the temperature of the cavity portion can be solely controlled precisely.

Also, the present invention can be an optical component manufacturing device to manufacture an optical component by injecting a molding material into a cavity between a fixed metallic mold and a movable metallic mold which are clamped and subject to temperature control, having an electrothermal conversion element disposed in the device to control temperature by electrothermal conversion in response to an electric input; a medium temperature control section to control temperature by heat exchange by circulating a heating medium in a medium flow path in the device thereof from outside of the device; wherein the fixed metal mold or the movable metal mold has a plurality of cavities having a molding plate and a molding surface, the medium temperature control section controls temperature of the cavities, and an electrothermal conversion element controls temperature of the portion of the fixed metal mold or the movable metal mold except the cavity. In the above device, a stable mold temperature can be also obtained with easy control by suppressing the effect of the atmospheric temperature.

Further, the present invention is also an optical component manufacturing method to manufacture an optical component by injecting a molding material into a cavity between a fixed metallic mold and a movable metallic mold which are clamped and subject to temperature control, controlling the electrothermal conversion element of the fixed metal mold or the movable metal mold by closed control while monitoring temperature of a portion heated by the electrothermal conversion element, using an electrothermal conversion element disposed inside the device to control temperature by electrothermal conversion in response to an electric input and a medium temperature control section to control temperature by heat exchange by circulating a heating medium in a medium flow path inside the optical component manufacturing device from outside the device thereof.

Further, in the present invention, it is preferred that observing from a direction perpendicular to a mold clamping direction, the electrothermal conversion element is disposed between the medium flow path of the medium temperature control section and the cavity.

### EFFECTS OF THE INVENTION

According to the optical component manufacturing device of the present invention and the manufacturing method thereof, a stable mold temperature can be obtained with easy control by suppressing the effect of atmospheric temperature.

### BRIEF DESCRIPTION OF THE DRAWINGS

FIG. 1 is a side view showing a main portion of an injection mold device related to the present invention.

FIG. 2 is an explanatory diagram showing an exemplary arrangement of electrothermal conversion elements for a molding plate and electrothermal conversion elements for cavities.

FIG. 3 is an explanatory diagram showing an exemplary arrangement of electrothermal conversion elements for a molding plate and electrothermal conversion elements for cavities.

FIG. 4 is an explanatory diagram showing a configuration of temperature control by an external temperature control unit.

FIG. 5 is a cross-sectional view showing a configuration of a heater plate.

FIG. 6 is an explanatory diagram showing an exemplary arrangement of electrothermal conversion element for the molding plate.

FIG. 7 is an explanatory diagram showing an exemplary arrangement of electrothermal conversion elements for a molding plate.

FIG. 8 is an explanatory diagram showing an exemplary arrangement of electrothermal conversion elements for a molding plate.

FIG. 9 is an explanatory diagram showing an exemplary arrangement of electrothermal conversion elements for a molding plate.

FIG. 10 is an explanatory diagram showing an exemplary arrangement of electrothermal conversion elements for a molding plate.

FIG. 11 is an explanatory diagram showing an exemplary arrangement of electrothermal conversion elements for a cavity.

FIG. 12 is an explanatory diagram showing an exemplary arrangement of electrothermal conversion elements for a cavity.

FIG. 13 is an explanatory diagram showing an exemplary arrangement of electrothermal conversion elements for a cavity.

FIG. 14 is an explanatory diagram showing an exemplary arrangement of electrothermal conversion elements for a cavity.

### DESCRIPTION OF SYMBOLS

5 Fixed metal mold
6 Movable metal mold
8 Medium temperature control section
11 Fixed side molding plate
14 Cavity
15, 17, 18, 19 and 25 electrothermal conversion element
16 and 26 piping
21 Movable side molding plate
22 Movable side receiving plate
31 Controller for electrothermal conversion element
32 External temperature control unit
39 Heater plate
41, 42, 43, 44, 45, 46, 47, 48, 51 and 52 Electrothermal conversion element

### DETAILED DESCRIPTION OF THE PREFERRED EMBODIMENTS

With reference to the attached drawings, a preferred embodiment of the present invention will be described in details as follow. The present embodiment is an example of the present invention applied to an injection mold device suitable for manufacturing a lengthen optical component such as a lens for a scanning optical system and a lens for a camera installed in a mobile phone.

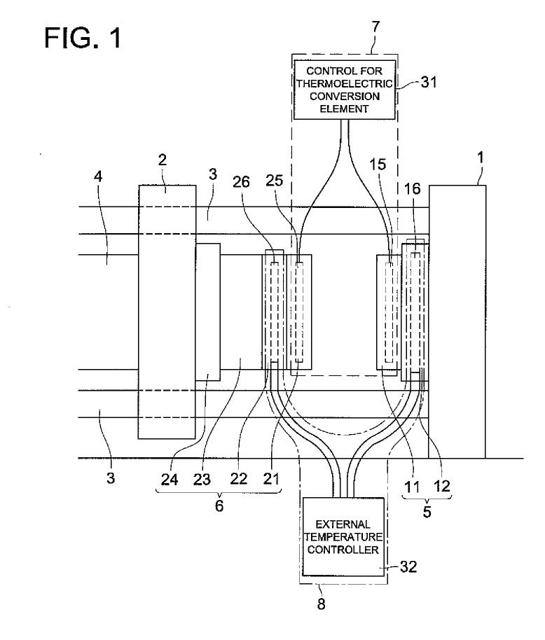

As FIG. 1 shows, a primary portion of the injection molding device of the present embodiment includes a fixed side platen 1 fixed on a base and a movable side platen 2 which can recede from and approach to the fixed side platen 1. A plurality of tie bars 3 penetrating the movable side platen 1 are provided parallel to each other. Each end of the tie bar 3 is fixed with a fixed side platen 1. Also, on the left side of the movable side platen 2 in the figure, there is provided a driving section 4 to move the movable side platen 2 back and forth i.e. left and right in the figure. Further, a fixing side metal mold 5 and a movable metal mold 6 are mounted on the fixed side platen 1 and the movable side platen 2 respectively.

AS FIG. 1 shows, the fixed metal mold 5 is provided with a fixed side molding plate 11 and a fixed sided attaching plate 12. Also as FIG. 1 shows, the movable metal mold 6 is provided with a movable side molding plate 21, a movable side receiving plate 22, a spacer block 23, and a movable side attaching plate 24. When clamping the mold, the movable side platen 2 is moved to left in the figure by the driving section 4, to clamp the fixed side molding plate 11 and movable side molding plate 21, thereby a cavity is formed therebetween.

In the present embodiment, temperature control by the electrothermal conversion is carried out for the fixed side molding plate 11 and the movable side molding plate 21, and temperature control by circulating a heating medium is carried out for the fixed side attaching plate 12 and the movable side attaching plate 22 as well. Thus, as FIG. 1 shows, the electrothermal conversion element 15 and electrothermal conversion element 25 are included in the fixed side molding plate 11 and the movable side molding plate 21 respectively, and both of the electrothermal elements are connected to the electrothermal conversion element controller 31. The electrothermal conversion element performs electrothermal conversion in response to an electric input by the electrothermal conversion element controller 31. Portions confined by broken lines 7 are subject to temperature control by electrothermal conversion.

Inside of the fixed side attaching plate 12 and the movable side receiving plate 22, piping 16 and piping 22 are configured respectively, and both piping are connected to an external temperature unit 32. The external temperature control unit 32 having a heating function and a pumping function performs temperature control by circulating the heating medium (oil or water), whose temperature is controlled appropriately, in the piping 16 and 26. Here, the portion including the piping 16 and 26, and the external temperature control unit 32 represents a medium temperature control section 8. As FIG. 1 shows, the electrothermal conversion elements 15 is disposed in between the piping 16 and the cavity, also the electrothermal conversion elements 25 is disposed in between the piping 26 and the cavity

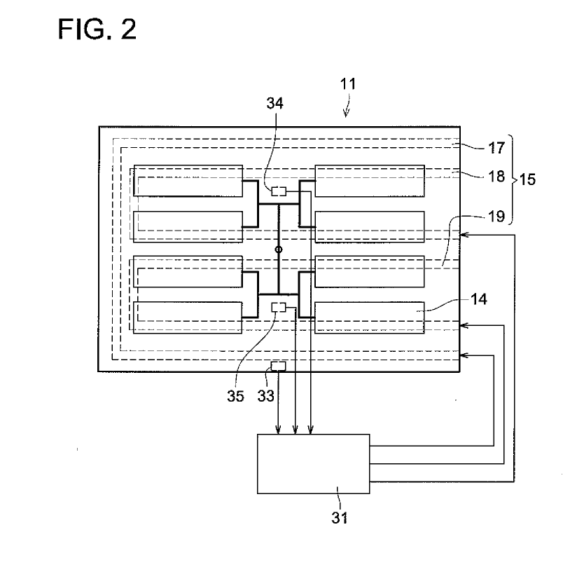

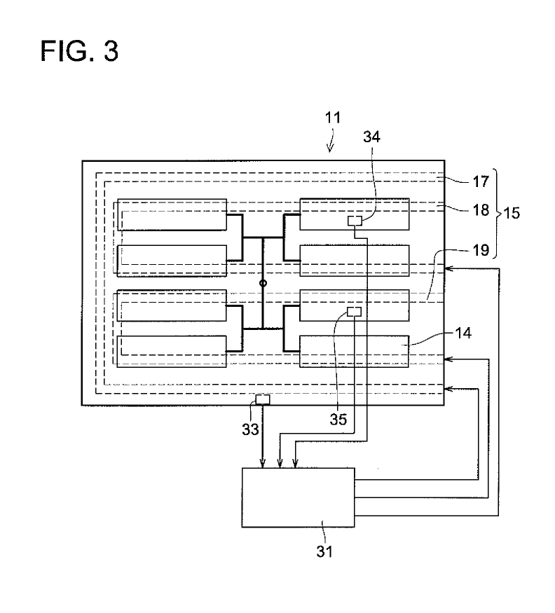

Next, the electrothermal conversion element 15 of the fixed side molding plate 11 will be described further. For example, as FIG. 2 or FIG. 3 shows, in the fixed side molding plate 11 to produce eight products molding products having eight cavities 14, there are provided an electrothermal conversion element 17 confining a periphery section of the molding plate 11 largely to control temperature of the molding plate 11 and the electrothermal conversion elements 18 and 19 to control temperature focusing on the cavity section. The electrothermal conversion element 17 is disposed at periphery side than all the cavities 14. Namely all the cavities 14 are disposed in an area confined by the electrothermal conversion elements 17 and a line segment connecting both ends of the element thereof. All the cavities 14 are subject to temperature control by either electrothermal conversion element 18 or 19. Whereby, the temperature difference between cavities 14 in consecutive molding can be within 2° C.

Further, at the fixed side molding plate 11, there are provided a temperature sensor 33 to monitor a temperature of a portion of the molding plate rather far from the cavity 14, and temperature sensors 34 and 35 to monitor temperature of cavity 14. The electrothermal conversion element controller 31 controls temperature of the electrothermal conversion element 17 with closed control in response to a result of the temperature sensor 33. Also, the electrothermal conversion element controller 31 controls the electrothermal conversion elements 18 and 19 in response to a result of the temperature sensors 34 and 35 respectively with closed control.

Here at, the closed control refers to a control method to repeat a loop where temperature of a vicinity of the portion to be controlled is measured directly, the measurement result is compared with a target value and an output to the electrothermal conversion element is controlled. Thus, since the closed control is carried out based on temperature of separate portions respectively, a highly accurate measuring is possible. Alternatively, by performing cascade control with providing two temperature sensors for each of electrothermal conversion elements 17, 18 and 19, even more accurate measuring with smaller variations is further possible.

It is also preferred for the movable side mold plate that the electrothermal conversion element for the molding plate largely confining the periphery section of the molding plate in the same manner as the fixed side molding plate 11 and the electrothermal conversion element for the cavity to control temperature focusing on the cavity section are used in combination. The same arrangement as that of the electrothermal conversion element of the fixed side molding plate 11 can be possible, and the arrangement slightly different can be also possible. As above, by the electrothermal conversion element for the molding plate, the effect of atmospheric temperature can be moderated and temperature distribution inside the mold can be made even. Thereby, molding stability is enhanced by suppressing performance difference among the cavities.

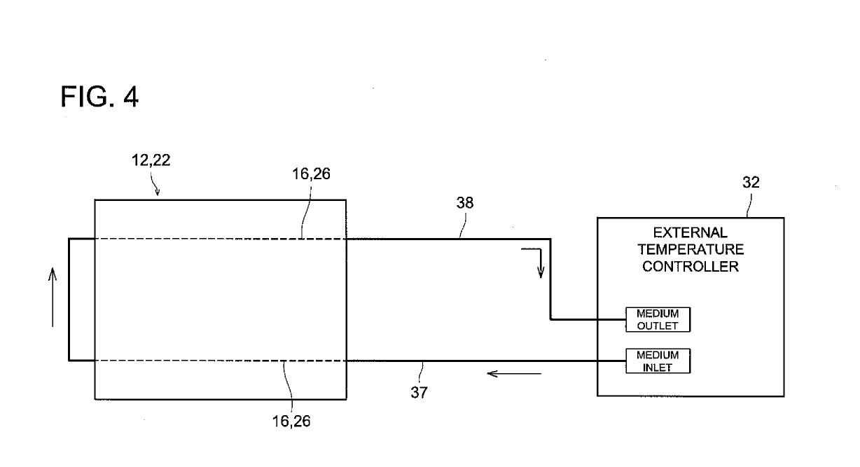

Further, in the injection mold device of the present embodiment, as FIG. 4 shows, the fixed side attaching plate 12 and the movable side receiving plate 22 are connected to the external temperature control unit 32, and a temperature control hoses 37 and 38 for connection are connected to the medium outlet and the medium inlet of the external temperature control unit 32 respectively. The temperature control hoses 37 and 38 are connected to the piping 16 inside the fixed side attaching plate 12 so as to circulate the heating medium via inside of the fixed side attaching plate 12. In the same manner, the temperature control hoses 37 and 38 are connected to the piping 26 of the movable side receiving plate 22 to circulate the heating medium via inside of the movable side receiving plate 22.

Meanwhile, the external temperature control unit 32 tends to be affected by atmospheric temperature since it is temperature control by medium flow. At successive molding in particular, it is known that temperature fluctuate ±1° C. even in an air-conditioned room. Contrarily, even in case temperature of a member having large thermal capacity is controlled, the cost is not very high and control is relatively easy.

On the other hand, since the electrothermal conversion elements 17 to 19 have preferable response in respect to an input of electric power, precise control is possible. In contrast, control becomes complicated and costly to perform temperature control of an entire member having a large thermal capacity. Thus in the present embodiment, by using above methods in combination, the temperature of the cavity can be controlled precisely while eliminating effects of atmospheric temperature.

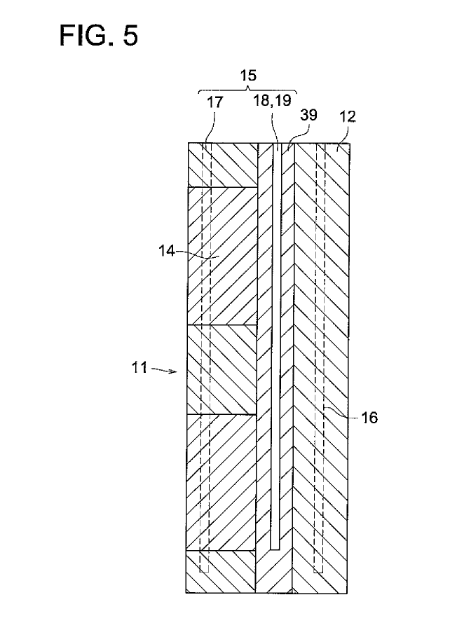

Meanwhile, the electrothermal conversion elements 18 and 19 can be disposed across the cavity 14 as described in the forging. However, considering workability of replacing work of the electrothermal conversion elements 18 and 19, the elements can be disposed to an immediate vicinity of the cavity 14 inside the fixed side molding plate 11. Alternatively, for example, as FIG. 5 shows the electrothermal conversion elements 18 and 19 can be installed in the heater plate 39 which is disposed between the fixed side molding plate 11 and fixed side attaching plate 12. In this way, replacing work can be even easier. Also, in an example in FIG. 2, while the electrothermal conversion element for the molding plate and the electrothermal conversion element for the cavity are used in combination, either of them can be solely used.

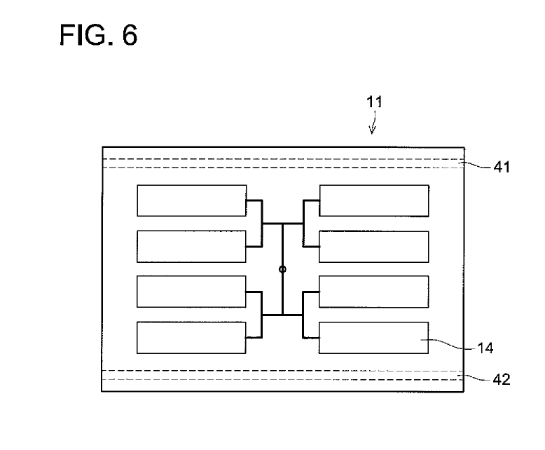

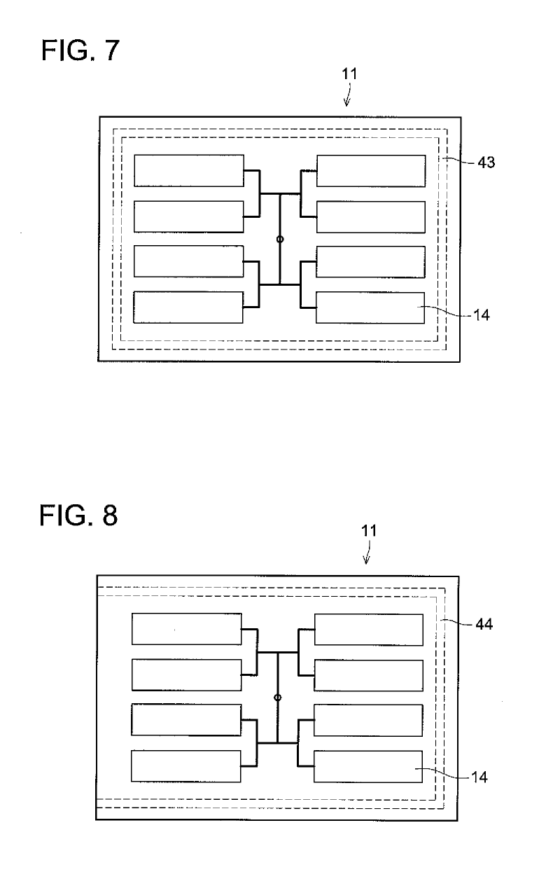

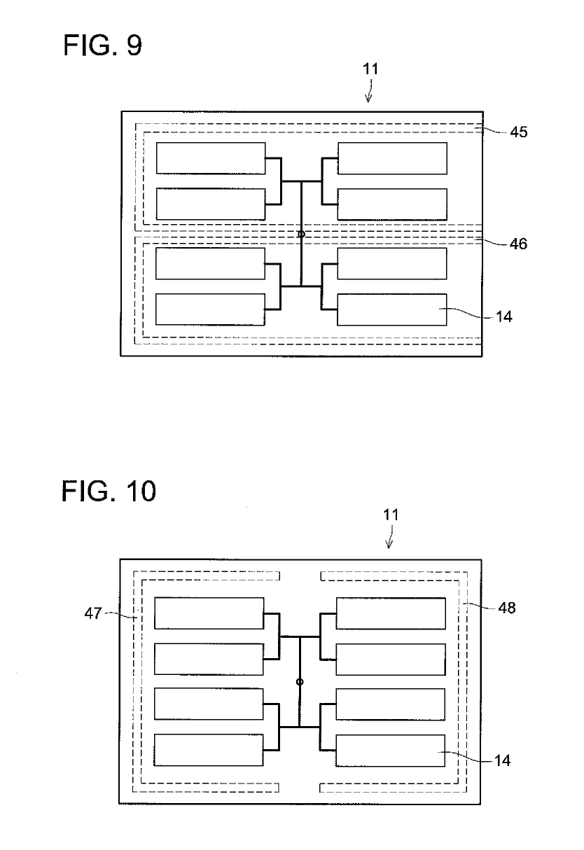

Also, an arrangement of electrothermal conversion element for molding plate shown in FIG. 2 can be substituted by arrangements shown in FIG. 6 to FIG. 10. For example, as FIG. 6 shows, two electrothermal conversion elements 41 and 42 can be disposed along an upper side and a lower side of the fixed side molding plate 11 in the figure. Or, as FIG. 7 shows, the electrothermal conversion element 43 can be disposed at an entire circumference of the fixed side molding plate 11. Alternatively, as FIG. 8 shows, the electrothermal conversion element 44 having an opening at an opposite side in respect to FIG. 2 is possible. Also as FIGS. 9 and 10 show, the electrothermal conversion element for the molding plate can be separated into two parts as broken lines show. In FIG. 9, the electrothermal conversion element is split in two electrothermal conversion elements 45 and 46 above and below, and in FIG. 10 the electrothermal conversion element is split in two electrothermal conversion elements 47 and 48 left and right.

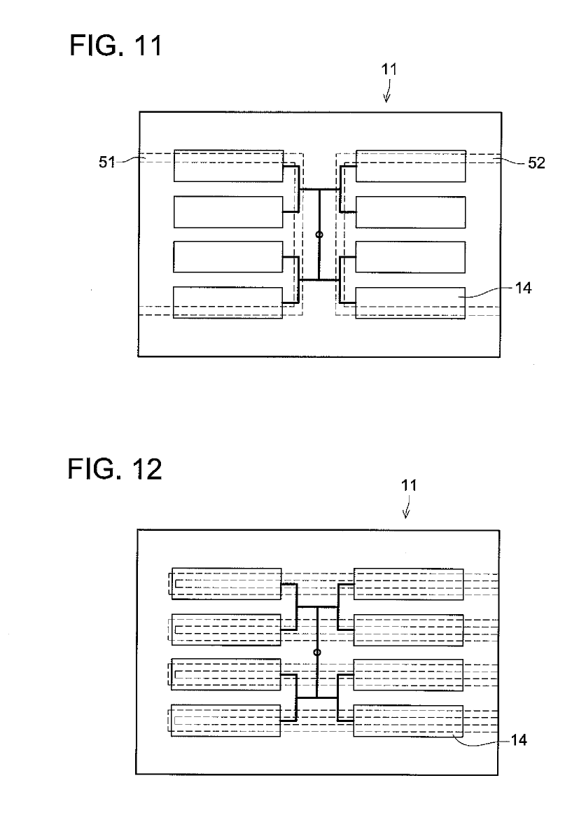

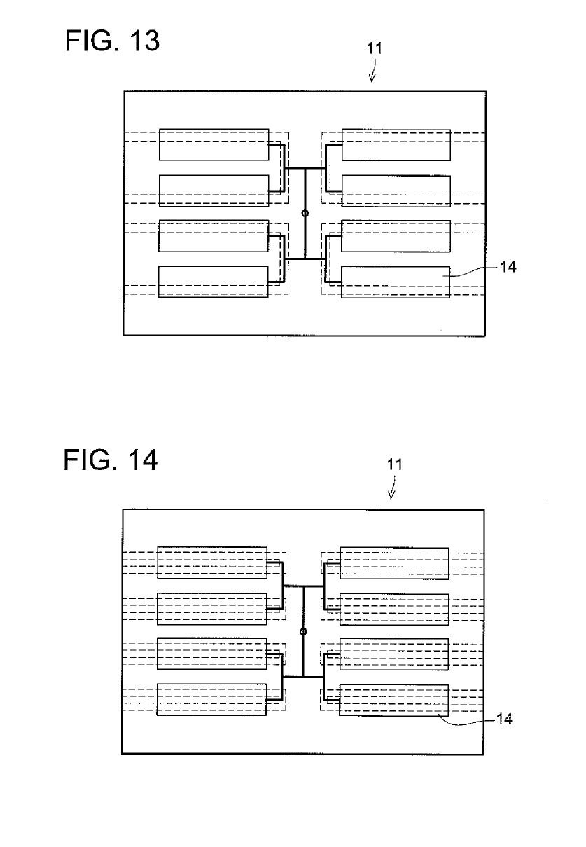

Also, instead of the electrothermal conversion elements 18 and 19 for the cavity shown in FIG. 2, the electrothermal conversion element can be arranged as FIGS. 11 to 14 show. For example, as FIG. 11 shows, the electrothermal conversion elements 51 and 52 can be arranged respectively left and right, where eight cavities are split left and right in the figure. Also, the electrothermal conversion element is not limited to two channel arrangement where two electrothermal conversion elements for the cavities are disposed. Four channels or eight channels are possible. Here, an example where the electrothermal elements for the cavities are formed in four channels is shown in FIGS. 12 and 13, and an example where the electrothermal elements for the cavities are formed in eight channels is shown in FIG. 14 respectively. Though the control becomes complicated as the number of channels increases, more precise temperature control is possible. The electrothermal conversion element is appropriately selected in accordance with size of the cavity and required accuracy. Meanwhile, in FIGS. 11 to 14, while illustrations of the electrothermal conversion elements for the molding plate are omitted, in practice, it is preferable to provide the electrothermal conversion elements for the molding plate.

Also, in accordance with conditions such as size and number of the products, the following are possible. Namely, only cavities are subject to temperature control by the electrothermal conversion element. Piping can be installed so as to circulate the heating medium in the portions subject to temperature control by the electrothermal conversion elements of the molding plate in the descriptions in the forgoing, to make it a part of the medium temperature control section. As above, temperature control with ease in control can be performed while suppressing the effect of atmospheric temperature.

Alternatively, temperature control of the cavity 14 can be performed by flow of the medium using the external temperature control unit 32 by arranging the piping in the same position as that of the electrothermal conversion element for the cavity as FIGS. 11 to 14 show. In this instance, it is preferred that temperature control the molding plate is carried out by the electrothermal conversion element for the molding plate.

Next, an optical component manufacturing method using an injection mold device of the present embodiment. First, the electrothermal conversion element controller 31 and the external temperature control unit 32 are operated to heat the fixed metal mold 5 and the movable metal mold 6 up to a predetermined temperature. Then, the movable side platen 2 is moved by the drive section 4 to clamp the molds. In a state of clamping mold, a melting resin is injected from outside of the fixed side platen 1. The injected resin infiltrates into the cavity through a formed flow path. When the injected resin is cooled in the cavity 13 and solidified, the resin is taken out. Whereby, the optical components are manufactured. When this occurs, since temperature of each cavity is appropriately controlled by the medium temperature control section and the electrothermal conversion elements, variations of cavity temperature and the effect of the atmospheric temperature are eliminated. As the resins used for molding, polyolefin series, polycarbonate, polyester series, acrylic, norbornene series and silicon are preferred.

As described in the forgoing, in the injection mold device of the present embodiment, the molding plate electrothermal conversion element using the electrothermal conversion elements and the cavity electrothermal conversion elements are disposed in the fixed side molding plate 11 and movable side molding plate 21, and the medium temperature control section using the external temperature control unit 32 is disposed at the fixed side attaching plate 12 and movable side receiving plate 22. The electrothermal conversion element enables precise temperature control though it is not suitable for temperature control for the member having large thermal capacity. Contrarily, the medium temperature control section is suitable for the member having large thermal capacity though it tends to be affected by atmospheric temperature. By combining the above devices, the metal mold for injection molding related to the present invention realizes stable molding temperature with ease in control by suppressing the effects of the atmospheric temperature.

The embodiments have been described, by way of example only, without the present invention being limited thereto, and it is to be understood that changes and variations my be made without departing from the spirit or scope of the appended claims.

For example, in the present invention, while the fixed side molding plate 11 and movable side molding plate 21 are subject to the same temperature control, the temperature control can be performed only for one of them, depending on configuration of the metal mold or a shape of the products. Also, in case the molding plate electrothermal conversion element can perform precise temperature control sufficiently, the cavity electrothermal conversion element can be omitted. In addition, in the present embodiment, while the present invention is applied to the metal mold to produce eight products, it can be applied to metal molds to produce four products or sixteen products without being limited to the metal mold to produce eight products. Further, the optical products are not limited to lengthly products.

What is claimed is:

1. An optical component manufacturing device to manufacture an optical component by injecting a molding material into a cavity between a fixed metal mold and a movable metal mold which are clamped and subject to temperature control, comprising:
an electrothermal conversion element disposed in the optical component manufacturing device to perform temperature control by electrothermal conversion in response to an electric input; and
a medium temperature control section to perform temperature control by heat exchange by circulating a heating medium in a medium flow path in the optical component manufacturing device from outside the device thereof.

2. The optical component manufacturing device of claim 1, wherein observing from a direction perpendicular to a mold clamping direction, the electrothermal conversion element is disposed between a medium flow path of the medium temperature control section and the cavity.

3. The optical component manufacturing device of claim 1, further comprising:
a base member to retain the fixed metal mold or the movable metal mold;
wherein the electrothermal conversion element is disposed at the fixed metal mold or the movable metal mold and a medium flow path of the medium temperature control section is disposed at the base member.

4. The optical component manufacturing device of claim 3, wherein
the fixed metal mold or the movable metal mold has a plurality of cavities having a molding plate and a molding surface,
the electrothermal conversion element includes a cavity electrothermal conversion element to perform temperature control of the cavity and a molding plate electrothermal conversion element to perform temperature control of the molding plate, and
a control section performs temperature control by controlling the cavity electrothermal conversion element and the molding plate electrothermal conversion element by closed control while monitoring temperatures of the cavity and the molding plate.

5. The optical component manufacturing device of claim 4, wherein the cavity electrothermal conversion element is disposed in the cavity.

6. The optical component manufacturing device of claim 4, the fixed metal mold or the movable metal mold has a heater plate, in which the cavity electrothermal conversion element is built-in, between the cavity and the based member.

7. The optical component manufacturing device of claim 4, wherein all the cavities are disposed within an area confined by the molding plate electrothermal conversion element and a line segment connecting both ends of the molding plate electrothermal conversion element thereof.

8. The optical component manufacturing device of claim 1, wherein
the fixed metal mold or the movable metal mold has a plurality of cavities having molding surfaces,
the electrothermal conversion element performs temperature control of the cavities, and
the medium temperature control section performs temperature control for portions of the fixed metal mold and movable metal mold except the cavities.

9. An optical component manufacturing device to manufacture an optical component by injecting a molding material into a cavity between a fixed metal mold and a movable metal mold which are clamped and subject to temperature control, comprising:
an electrothermal conversion element disposed in the optical component manufacturing device to perform temperature control by electrothermal conversion in response to an electric input; and
a medium temperature control section to perform temperature control by heat exchange by circulating a heating medium; wherein
the fixed metal mold or the movable metal mold has a plurality of cavities having molding surfaces,
the medium temperature control section performs temperature control of the cavities, and
the electrothermal conversion element performs temperature control for portions of the fixed metal mold and movable metal mold except the cavity.

10. An optical component manufacturing method to manufacture an optical component by injecting a molding material into a cavity between a fixed metal mold and a movable metal mold which are clamped and subject to temperature control, comprising steps of:
using an electrothermal conversion element disposed in a optical component manufacturing device to perform temperature control by electrothermal conversion in response to an electric input, and a medium temperature control section to perform temperature control heat exchange by circulating a heating medium in a medium flow path inside an optical component manufacturing device from outside the device thereof; and
controlling the electrothermal conversion element of the fixed metal mold or the movable metal mold by closed control while monitoring temperature of a portion heated by the electrothermal conversion.

11. The optical component manufacturing method of claim 10, wherein observing from a direction perpendicular to a mold clamping direction, the electrothermal conversion element is disposed between the medium flow path of the medium temperature control section and the cavity.
